(19) United States
(12) Patent Application Publication
(10) Pub. No.: US 2026/0087400 A1
(43) Pub. Date: Mar. 26, 2026

(54) Validating Cached Inputs to a Machine-Learned Model System

(71) Applicant: Google LLC, Mountain View, CA (US)

(72) Inventors: Branden Michael Archer, Mountain View, CA (US); Mekhola Mukherjee, San Francisco, CA (US)

(21) Appl. No.: 18/891,834

(22) Filed: Sep. 20, 2024

(51) Int. Cl. G06N 20/00; H04L 9/32

(52) U.S. Cl. CPC G06N 20/00; H04L 9/3247

(57) ABSTRACT

An example method for validating data at a node in a hierarchical input pipeline for a machine-learned model system includes receiving, from a first child node of the node, a first input context component. The example method includes receiving, from a second child node of the node, a second input context component. The example method includes generating, at a context generation time, an output context component based on a validated set of context components comprising at least the first input context component. In the example method: the validated set of context components includes the second input context component based on receiving, from the second child node, a communication that indicates a valid context status for the second input context component at the context generation time; or the validated set of context components does not comprise the second input context component based on not receiving the communication that indicates the valid context status at the context generation time. The example method includes outputting, to a parent node of the node, the output context component.

### FIELD

The present disclosure relates generally to machine learning processes and machine-learned devices and systems. More particularly, the present disclosure relates to validating cached inputs to a machine-learned model system.

### BACKGROUND

A computer can receive inputs. The computer can execute instructions to process the inputs to generate outputs using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

In an aspect, the present disclosure provides a first example method. In some implementations, the first example method includes receiving, from a first child node of the node, a first input context component. In some implementations, the first example method includes receiving, from a second child node of the node, a second input context component. In some implementations, the first example method includes generating, at a context generation time, an output context component based on a validated set of context components comprising at least the first input context component. In some implementations of the first example method, the validated set of context components includes the second input context component based on receiving, from the second child node, a communication that indicates a valid context status for the second input context component at the context generation time. In some implementations of the first example method, the validated set of context components does not comprise the second input context component based on not receiving the communication that indicates the valid context status at the context generation time. In some implementations, the first example method includes outputting, to a parent node of the node, the output context component.

In an aspect, the present disclosure provides a second example method. In some implementations, the second example method includes receiving, from one or more child nodes of the node, one or more input context components. In some implementations, the second example method includes generating, based on the one or more input context components, an output context component. In some implementations, the second example method includes outputting, to a parent node of the node, the output context component. In some implementations, the second example method includes storing a data record that associates the one or more input context components with the outputting of the output context component to the parent node. In some implementations, the second example method includes receiving, from at least one of the one or more child nodes, an update to at least one of the one or more input context components. In some implementations, the second example method includes initiating, based on the data record, the generation of a replacement context component for the output context component, the replacement context component based on the update. In some implementations, the second example method includes, based on generating the replacement context component, outputting, to the parent node, the replacement context component to replace the output context component. In some implementations, the second example method includes, based on detecting an alignment between the replacement context component and the output context component, not outputting, to the parent node, the replacement context component to replace the output context component.

In one example aspect, the present disclosure provides example non-transitory computer readable media storing instructions that are executable by one or more processors to cause a computing system to perform one or more operations of any one or more implementations of the first example computer-implemented method or the second example computer-implemented method.

In one example aspect, the present disclosure provides a first example computing system comprising one or more processors and the example non-transitory computer readable media.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to describe the related principles.

### BRIEF DESCRIPTION OF THE DRAWINGS

Detailed discussion of embodiments directed to one of ordinary skill in the art is set forth in the specification, which makes reference to the appended figures.

FIG. 1 is a block diagram of aspects of an example system for using a context tree according to example aspects of the present disclosure for executing inference using one or more machine-learned model(s).

FIG. 2 is a data flow diagram of aspects of an example system for using a context tree according to example aspects of the present disclosure for executing inference using one or more machine-learned model(s).

FIG. 3 is a data flow diagram of aspects of an example system for using a context tree according to example aspects of the present disclosure for executing inference using one or more machine-learned model(s).

FIG. 4 is a data flow diagram of aspects of an example system for using a context tree according to example aspects of the present disclosure for executing inference using one or more machine-learned model(s).

FIG. 5 is a flowchart of an example method for using an example context graph according to aspects of the present disclosure.

FIG. 6 is a flowchart of an example method for using an example context graph according to aspects of the present disclosure.

FIG. 7 is a flowchart of an example method for training one or more machine-learned models according to aspects of the present disclosure.

FIG. 8 is a block diagram of an example processing flow for using machine-learned model(s) to process input(s) to generate output(s) according to example implementations of aspects of the present disclosure.

FIG. 9 is a block diagram of an example sequence processing model according to example implementations of aspects of the present disclosure.

FIG. 10 is a block diagram of an example technique for populating an example input sequence for processing by a sequence processing model according to example implementations of aspects of the present disclosure.

FIG. 11 is a block diagram of an example model development platform according to example implementations of aspects of the present disclosure.

FIG. 12 is a block diagram of an example training workflow for training a machine-learned model according to example implementations of aspects of the present disclosure.

FIG. 13 is a block diagram of an inference system for operating one or more machine-learned model(s) to perform inference according to example implementations of aspects of the present disclosure.

FIG. 14 is a block diagram of an example networked computing system according to example implementations of aspects of the present disclosure.

FIG. 15 is a block diagram of an example computing device according to example implementations of aspects of the present disclosure.

FIG. 16 is a block diagram of an example computing device according to example implementations of aspects of the present disclosure.

Reference numerals that are repeated across plural figures are intended to identify the same features in various implementations.

### DETAILED DESCRIPTION

Example implementations of the present disclosure provide techniques and systems for validating cached inputs to machine-learned models. In many situations, machine-learned model systems that generate predictions based on input contexts can improve efficiency of operation by caching context data. This can allow for efficient generation of the same or different predictions as needed without re-collecting the input contexts from potentially a wide range of source systems. However, the use of caching presents a technical challenge for maintaining a current and valid cache. Example implementations of the present disclosure provide solutions to this technical challenge with a mechanism for validating the cached data via a hierarchical context source tree. In an example, each node in a context source tree can implement validation checks based on the data available to it (e.g., from its own child nodes) to ensure that the most recent context it has passed up the tree (e.g., to its parent node(s)) is current and valid. If not, the node can issue instructions to its parent to flush the invalid cached context or can send replacement context which causes the parent to flush the invalid context and replace it with the new context. Flushing the context can include deleting context components, regenerating predictions based on the context, retraining a model that was trained based on the context, etc.

For example, machine-learned models can be used to generate helpful prediction outputs based on a wide range of contextual signals. For example, prediction outputs can be implemented for controlling a computing device for performing one or more tasks on behalf of a user. For instance, a machine-learned model can generate instructions that invoke application programming interfaces (“APIs”) to perform various operations, such as sending messages, querying databases, parsing image or video content, etc. These predictions can be conditioned on diverse configurations of contextual inputs. For example, a user can enable an assistant application (e.g., that executes the machine-learned models) to access data from other applications on a device, such as a health application. The health application can itself aggregate data from different sources that the user has authorized to share with the health application, such as from different physician's offices that individually input data into their respective systems, connected wearable health tracking devices (e.g., a smartwatch). For example, the health application can maintain a schedule of upcoming appointments for a number of offices within a set of participating offices. By enabling the assistant application to access data from the health application, the assistant application can, for instance, generate predictions regarding calendar entries (e.g., generating an output to cause creation of a calendar entry associated with an upcoming appointment), generate predictions regarding textual completions (e.g., generating a suggested completion for the doctor's office address in a messaging application when the user is typing a message to a friend requesting the friend to meet the user at the doctor's office), or other predictive tasks.

In some cases, the collection of the context data itself can be nontrivial. For instance, the health application can itself process available context and generate health-related predictions, such as a predicted fitness level, recommended workout regimens, etc. These predictions can themselves be provided as contexts to the assistant application. The assistant application can use these component predictions to generate other predictions, such as for suggesting itineraries for hiking trips, identifying appropriate times in a weekly schedule for scheduling exercise, etc. The generation of the health-related predictions can employ machine-learned models that execute over available information for the health application.

Accordingly, caching contexts at the assistant application can provide performance improvements, potentially by avoiding regeneration of intermediate contexts. But while caching diverse contextual inputs can provide for improved prediction performance, caching can introduce potential opportunities for stale data. Stale data can include data that is no longer accurate due to changes in an underlying event or status that the data previously represented. Stale data can include data that is removed from an available data corpus. For example, with reference to the above example of the assistant application, the assistant application does not always have access to the same underlying data as the health application. As such, when the underlying data changes—such as when an appointment is rescheduled or canceled—any cached contexts stored at the assistant application may become stale.

Traditional approaches to customizing or adapting machine-learned models often fail to account for and trace the source of context data. In-context learning can refer to the use of contextual inputs to a machine-learned model that cause the model's outputs to reflect knowledge or understandings indicated by the contextual inputs, as if the model had “learned” that information. Traditional systems for in-context learning may compile textual prompts or other inputs to a machine-learned model and store the prompts simply as string values. Such a storage mechanism fails to account for dependencies in that textual prompt on upstream context sources that may change. As such there may be no method for validating such a stored prompt. Similarly, traditional approaches for training a machine-learned model may use training datasets to adjust the model parameters to customize a performance over the training dataset. Similarly, such traditional training techniques may fail to account for dependencies in the training data—and ultimately the model parameters themselves—on upstream context sources that may change.

Advantageously, example implementations of the present disclosure provide a framework to trace and respond to dependencies in context data used for customizing or adapting machine-learned models. An example framework includes pairwise cooperative systems that each validate the contexts that they provide. In an example, the framework can be represented as a graph of pairwise cooperative nodes. Leaf nodes can be data sources. By ensuring that communication downstream from each node reflects valid context, the valid context signals can be passed all the way from the sources to a root node that provides inputs to a machine-learned model system.

Context signals from child nodes can be accompanied by validation data. For instance, validation data can include an authentication certificate that establishes a duration of validity of the context, after which it must be flushed or a new certificate obtained. The operating node that receives the certificate can request a new certificate from the child node. This request can cause the child node to itself re-validate the context, propagating the validation sequence. Upon satisfaction of the validation routine, the validation signal can travel upstream back to the child node and back to the operating node in the form of a new certificate that authorizes use of the context (e.g., for a refreshed duration).

Some data sources can reliably be trusted to propagate data changes. As such a trust-based system may be implemented in which contexts received from a particular node are treated as current unless the node pushes a new update. This approach can decrease a communication cost and a computational cost by only regenerating contexts and requesting context updates on an as-needed basis.

Some data sources may be less reliable or the data issued thereby may be subject to greater precautions. In some cases a lower trust system may be implemented in which an operating node must periodically receive validation from its child nodes a current status of its contexts or else flush the contexts. The validations can be pushed from the child nodes or requested by the operating node.

Some data sources may be passive and may not be relied upon to push new updates. Data extracted from such a source may not be associated with any guarantees of currency after a single use after an authorized sharing of the data. Similarly, some data may be sensitive and any authorized use of such data may be limited to single use. In such cases a low-trust system may be implemented in which contexts dependent on such sources may expire after a single use.

Pairwise cooperation can follow a standard protocol or can be independently established between each pair of communicating systems. The pairwise cooperation can be facilitated using a signed certificate from a certifying entity that establishes compliance with a validation protocol. Communications from a child node that lack such a signature can be untrusted and any dependent contexts can be flushed from the contexts used by the operating node.

Advantageously, each participating node in the context tree can maintain a valid cache of contexts. In this manner, for instance, a context tree according to aspects of the present disclosure can effectively factorize the computation of context values over upstream portions of context. In this manner, a change to an individual source data item may only result in a partial graph rebuild over the affected portions of the graph. The computational cost of this partial rebuild can be less than a full rebuild.

Example implementations of the present disclosure can provide a number of technical effects and benefits. An example technical effect of example implementations of the present disclosure is the potential reduction in the computational cost associated with providing inferences based on inputs from diverse sources. For example, example implementations can facilitate improved caching, thereby enabling data to be efficiently retrieved for inferences. An improvement to the caching can be obtained by validating the cached data to maintain up-to-date cached data. Improved efficiency can be achieved by updating only the context representations along the path from an affected terminal node to the root, rather than recomputing the entire cache. Unaffected parts of the tree that are still valid can be carried forward without repeating their previous computations, decreasing computational cost and latency. This approach can be particularly beneficial for context trees that include some nodes that update more often than others.

Similarly, an example technical effect of example implementations of the present disclosure is improved latency of cache updates. For example, one node of the context tree can be an interactive application. In an example interactive applications, where user inputs can frequently alter the context (e.g., dialog-based assistant systems, content editing, etc.), the data from that source can update frequently. A context graph can facilitate rapid updates to the cache of the machine-learned model systems. Rather than recomputing the entire cache, only the affected branches of the graph—those that correspond directly to or obtain characteristics from the changed input—might need updating. This can result in a more responsive user interface and execution as the system can more quickly begin processing new inputs after spending less time updating the cache. Similarly, in streaming applications such as real-time sensor data analysis, where various different parts of input context changes as different sensor data streams in, the hierarchical structure of the cache framework as described in the present disclosure can facilitate higher responsiveness to new sensor data updates.

An example technical effect of example implementations of the present disclosure is improved data security. For example, stale data can introduce security vulnerabilities in a cache or a system operating the cache. The present disclosure provides solutions for validation of cached data, so that stale data can be purged. This in turn can provide for increased data security guarantees for data processing systems.

For instance, in an example, the present disclosure provides an example computer-implemented method for validating data at a node in a hierarchical input pipeline for a machine-learned model system. The example method can include receiving, from a first child node of the node, a first input context component, and receiving, from a second child node of the node, a second input context component. The example method can include generating, at a context generation time, an output context component based on a validated set of context components comprising at least the first input context component. For instance, the first input context component can be associated with a valid status and maintained in a cache for generating context components with improved efficiency. As further described herein, in an example implementation, the validated set of context components can include the second input context component based on receiving, from the second child node, a communication that indicates a valid context status for the second input context component at the context generation time. In this manner, for instance, the generation of the output context component can be based on confirming a valid status for the input context components. This can help ensure that data security and sharing parameter configurations are respected throughout a data sharing environment. In an example implementation, the validated set of context components does not comprise the second input context component based on not receiving the communication that indicates the valid context status at the context generation time. In this manner, for instance, the generation of the output context component can omit use of data for which a confirmed valid status is not obtained. This can help ensure that data security and sharing parameter configurations are respected throughout a data sharing environment.

In another example, for instance, the present disclosure provides an example computer-implemented method for validating data at a node in a hierarchical input pipeline for a machine-learned model system. The example method can include receiving, from one or more child nodes of the node, one or more input context components, and generating, based on the one or more input context components, an output context component. The example method can include outputting, to a parent node of the node, the output context component. The example method can include storing a data record that associates the one or more input context components with the outputting of the output context component to the parent node. In this manner, for instance, a node can maintain a record of dependencies of output context components on input context data. This record can facilitate the updating of context components based on detected changes (e.g., changes to data, changes to authorizations). For example, the example method can include receiving, from at least one of the one or more child nodes, an update to at least one of the one or more input context components and initiating, based on the data record, the generation of a replacement context component for the output context component, the replacement context component based on the update. The replacement can be output to a downstream node. For instance, the example method can include, based on generating the replacement context component, outputting, to the parent node, the replacement context component to replace the output context component. The replacement process can be terminated if the replacement will be identical to the original. For instance, the original context component may not have an identifiable dependency to the data that was changed. As such, the replacement can be skipped and not output downstream, so as to decrease an amount of recomputation if not needed. For instance, the example method can include, based on detecting an alignment between the replacement context component and the output context component, not outputting, to the parent node, the replacement context component to replace the output context component.

Example implementations of the present disclosure are described in more detail herein with respect to the enclosed figures.

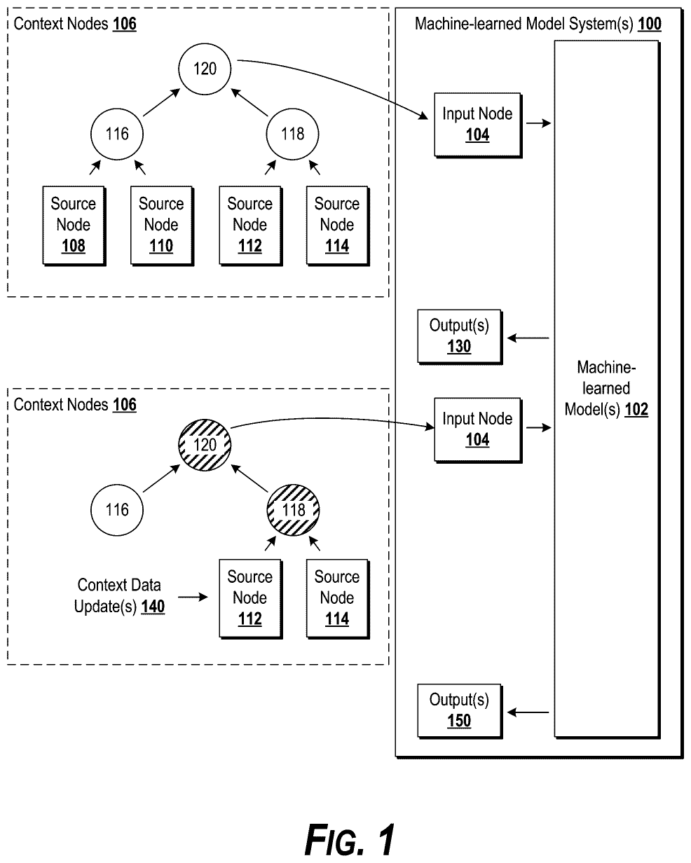

FIG. 1 is a block diagram of an example system for using a context graph to validate context data according to example aspects of the present disclosure for executing inference using one or more machine-learned model(s). In an example, a context graph can form a tree structure of nodes. The tree structure can represent a hierarchical data structure that builds layer upon layer to obtain representations of context based on preceding layers.

Machine-learned model system(s) 100 can provide access to and execution of one or more machine-learned model(s) 102 based on provided input data. Input data can be provided to the models from input node 104. Input node 104 can source context data for input to the models from context nodes 106. Context nodes 106 can represent sources of data or aggregations or transformations thereof that provide context for one or more inference operations of machine-learned model system(s) 100.

For example, context nodes 106 can contain terminal nodes that respectively correspond to data sources (e.g., devices or systems from which context data originates or is introduced into a network of context nodes 106). For instance, source node 108 can contribute a context component (e.g., one or more context data objects) to node 116. Node 116 can perform one or more operations on the data from source node 108. Source node 110 can contribute a context component to node 116. Node 116 can perform one or more operations on the data from source node 110. The operations can be context aggregation or generation operations. The operations can be context validation operations. Similarly, source nodes 112 and 114 can contribute context components to node 118, and node 118 can perform one or more operations on the data from source nodes 112 and 114. The operations can be context aggregation or generation operations. The operations can be context validation operations.

Each of nodes 116 and 118 can generate context components based on one or more inputs, such as the received context data from the source nodes. Nodes 116 and 118 can output context components to a downstream node, such as node 120. Node 120 can be a context management node that provides validated context data to input node 104. Node 120 can perform one or more operations on the data from nodes 116 and 118. The operations can be context aggregation or generation operations. The operations can be context validation operations.

Upon generation or validation, node 120 can provide an output context component to input node 104. Input node 104 can include an input interface for machine-learned model system(s) 100 (e.g., an application programming interface, “API”). Machine-learned model system(s) 100 can input data to machine-learned model(s) 102 based on context elements received by input node 104. Based on the input data, machine-learned model(s) 102 can generate outputs 130.

All or part of the context received and generated by any one of context nodes 106 can be cached to reduce a computational cost of subsequent updates. For example, in a subsequent update, at least a portion of context nodes 106 can be retrieved from a cache for executing inference over the same context. Advantageously, the cached values can be updated responsive to updates to the context data without requiring a full graph rebuild.

Context data update(s) 140 can include any change to part of any source data of one of the source nodes. For instance, context data updates 140 can include a new context value or a replacement context value (e.g., for context from a health application, a context data update can include a new appointment scheduled for a user). Context data updates 140 can include updates to attributes associated with context values. For instance, context data updates can include a change to an authorization attribute associated with the context data values. For instance, a change to a data sharing parameter of an application can be a context data update.

To propagate the changes to the context data (e.g., an addition change, a deletion change, an authorization change, etc.), the context representations of context nodes 106 can be partially rebuilt. For instance, source node 112 can receive context data updates 140. Source node 112 can push the update to node 118 or node 118 can request and receive the update. Node 118 can determine that the update necessitates an updated output context component (e.g., the previously generated context component issued to node 120 is stale). Node 118 can initiate replacement of the output context component previously issued to node 120. Node 118 can reuse cached data from source node 114 based on a determined validity of the cached data. Similarly, node 118 can push the update to node 120 or node 120 can request and receive the update. Node 120 can determine that the update necessitates an updated output context component (e.g., the previously generated context component issued to node 104 is stale). Node 120 can initiate replacement of the output context component previously issued to node 104. Node 120 can reuse cached data from node 116 based on a determined validity of the cached data.

The updated output context component can be sent to node 104 to replace any stale context. If output 130 is also stale, machine-learned model system(s) 100 can execute inference over the updated output context component received by node 104 from node 120 to generate refreshed output(s) 150.

Machine-learned model system(s) 100 can provide an interface configured to facilitate executing one or more machine-learned models. Machine-learned model system(s) 100 can include a model host system that hosts and executes a machine-learned model (e.g., an on-device model). Machine-learned model system(s) 100 can include an application programming interface (API) or software development kit (SDK) that controls or instructs one or more model host system(s) remote from a computing device executing the API or SDK (e.g., cloud-hosted models).

Machine-learned model system(s) 100 can be or include one or multiple computing devices or systems. Machine-learned model system(s) 100 can locally execute a machine-learned model on a same device or system that contains one or more portions of context data (e.g., one or more of source nodes 108 to 114), such as a user device. Machine-learned model system(s) 100 can execute a machine-learned model on a remote server. Machine-learned model system(s) 100 can control model inference on the remote server using instructions (e.g., API calls) issued from a local device (e.g., a user device).

Machine-learned model system(s) 100 can include or facilitate interactions with machine-learned model(s) that provide predictions based on input context. A machine-learned model can generate a predicted output based on an input. The input can be or include context used to condition the predicted output. For instance, one or more portions of the output can be selected based on a value that, based on one or more portions of the input, is associated with a higher probability value than would be present if the one or more portions of the input were different.

Example implementations of machine-learned model 102 are described below with respect to machine-learned model 1.

Input node 104 can include one or more processing components or layers configured to receive context from node 120 (or other root nodes of other context trees) and prepare inputs for input to models in machine-learned model system 100. Preparing inputs can include combining data from one or more context components with one or more other input components (e.g., instructions, prompts, latent encodings, etc.).

Context nodes 106 can be implemented over one or more computing devices or systems. For example, each node can correspond to an individual computing device or system. A computing device or system can implement one or more of context nodes 106. A node can be implemented using hardware or software configured to execute one or more context data processing operations.

Source nodes 108, 110, 112, 114 can correspond to devices or systems that originate data into a system of context nodes 106. For example, sources nodes can include individual devices associated with a user. Source nodes can include, for example, a mobile device (e.g., a phone, tablet, etc.), a wearable device (e.g., a smartwatch, headset or earbuds, lapel pin, etc.), a personal computer (e.g., laptop, workstation, cloud instance, etc.), or any other computing device associated with or used in conjunction with a user account. Sources nodes can include devices or systems otherwise associated with a user, such as a computing system of a service provider, such as a healthcare service provider, a shopping service provider, a software service provider (e.g., productivity application software, such as image editing, text editing, video editing, or other software), a transportation service provider, or other service provider with which a user engages to obtain products or services and whom the user has authorized to participate in the context aggregation of context nodes 106. The data can be generated on or using a computing device associated with source nodes. Source nodes 108, 110, 112, 114 can curate and relay data input to or retrieved by source nodes 108, 110, 112, 114.

Nodes 116 and 118 can be example intermediate nodes that can perform intermediate processing steps. Intermediate processing steps can operate on lower-level contextual representations to generate context components that more densely represent attributes of interest. For instance, source data nodes can publish general datasets or signals to downstream nodes. The published context can be generic and not task-specific. One or more of nodes 116 or 118 can perform task-specific context extraction, such as by performing inference on the input data to extract feature values that are associated with task-specific attributes of interest. For instance, in an example, the source nodes include various wearable devices that collect biometric data such as heart rate and activity levels. Node 116 can execute algorithms designed to infer stress levels from these biometric readings. This inference may use signal preprocessing systems to process input signals and use then machine-learned inference systems to output predictions associated with stress levels. The output from node 116 would thus be a more refined context signal that highlights stress-related context. The same source data can be processed by different nodes (e.g., node 118) to extract different features, such as an amount of progress along an exercise plan or regimen.

Node 120 can be an example root node of context nodes 106. As a root node, node 120 can collect and compile validated context components for providing to input node 104 of machine-learned model system(s) 100. Node 120 can perform contextual feature generation, aggregation, or extraction. Node 120 can perform validation of context components received from its child nodes. Node 120 can output context component(s) to input node 104 for input to a machine-learned model.

Context data processed at a node can include a variety of data in one or multiple datatypes. Context data can include one or multiple modalities of data, such as text or other symbolic data, audio, imagery (e.g., still or video), etc. Context data can be input by a user, obtained from one or more sensors of a device, retrieved from storage, received over a network, etc. At least a portion of context data can be generated by machine-learned models executing at or on behalf of each node.

For example, a node can receive context components in one or more modalities and generate context components in one or more modalities (e.g., the same modalities, different modalities). A node can generate output context components by filtering, aggregating, transforming, or otherwise processing input context components. A node can generate output context components using machine-learned model(s) to perform inference over input context components. For instance, a node can perform summarization, classification, etc. over a collection of input context components.

For example, a node can receive input context components as text and generate an output context component as text. The node can include a machine-learned model that has been trained to perform text summarization. The node can receive a collection of text documents as input context components. The node can use the machine-learned model to generate a summary of the documents. The summary can be output as the output context component.

For example, a node can receive input context components as audio and generate an output context component as text. The node can include a machine-learned model that has been trained to perform speech-to-text transcription. The node can receive a collection of audio recordings as input context components. The node can use the machine-learned model to generate a transcript of the audio recordings. The transcript can be output as the output context component.

For example, a node can receive input context components as images and generate an output context component as text. The node can include a machine-learned model that has been trained to perform image captioning. The node can receive a collection of images as input context components. The node can use the machine-learned model to generate a caption for the images. The caption can be output as the output context component.

For example, a node can receive input context components as text and generate an output context component as a latent embedding. The node can include a machine-learned model that has been trained to perform text encoding. The node can receive a collection of text documents as input context components. The node can use the machine-learned model to generate a latent embedding for each of the text documents. The latent embeddings can be output as the output context component.

For example, a node can receive input context components as a list of items and generate an output context component as a sorted list of items. The node can use a sorting algorithm, such as bubble sort, insertion sort, or merge sort, to sort the items in the list. The sorted list can be output as the output context component.

For example, a node can receive input context components as a collection of time series data and generate an output context component as a collection of time series data. The node can include a machine-learned model that has been trained to perform time series forecasting. The node can receive a collection of time series data as input context components. The node can use the machine-learned model to generate forecasts for the time series data. The forecasts can be output as the output context component.

For example, a node can receive input context components as a set of numerical values and generate an output context component as a single numerical value. The node can include a machine-learned model that has been trained to perform regression. The node can use the machine-learned model to predict a value based on the input numerical values. The predicted value can be output as the output context component.

The processing in the nodes can include operations more complex than data passthrough. Example processes can perform non-trivial transformations on the data. These transformations can involve operations like aggregation, feature extraction, dimensionality reduction, or encoding, potentially altering the data structure or representation. These transformations may or may not be reversible, meaning the original data might not be fully recoverable from or traceable to the transformed version. The hierarchical structure of the context nodes of the present disclosure can enable traceability of inputs to outputs, allowing for the propagation of changes and the erasure of stale contexts. Each node can maintain a record of its dependencies on upstream nodes, enabling the systems to identify and update the affected portions of the context graph when changes occur. This approach helps to ensure that changes can be propagated efficiently, while stale contexts can be erased, preserving data integrity and facilitating efficient updates.

In an example, the nodes within the context graph may form a non-trivial directed graph containing cycles. The flow of data can be more complex than an open loop of nodes. For example, a node can receive input from multiple other nodes, and its output can be used as input to multiple other nodes, possibly even feeding back into itself or one of its child nodes. This allows for more sophisticated data processing and context representation (e.g., using iterative refinement mechanisms). For example, a node could receive input from multiple sources, each providing a different aspect of the context. The node could then combine these inputs to generate a more comprehensive representation of the context. This could involve aggregating data from multiple sources, performing feature extraction on the input data, or applying dimensionality reduction techniques to reduce the complexity of the data. This high-level representation can be used by the child nodes to update one or more of the inputs. The updated inputs can then be processed by the node to update the high-level representation. This example cycle can repeat for one or more iterations.

Graph cycles can be treated to prevent stale data from re-entering the system through feedback loops. For example, in addition to deleting stale data cached by a node, any stale feedback signals based on that data can be deleted as well. For instance, when data is removed or edited, all cached results within the cycle can be flushed before any recomputation of a node's values.

In some examples, a node in the context graph may receive numerous update requests. A batching mechanism can be implemented that groups multiple update requests into a single batch and processes them together. Batching can improve efficiency by reducing the overhead associated with individual processing operations. For example, a node can compute daily updates for an output context component. Update requests received throughout the day can be accumulated in a queue and applied in batches for the next recomputation. In this manner, the node can operate with an update latency of at most one day. The batch cycle time can be adjusted to adhere to a desired update latency.

In an example, the validation of data communicated via the context tree can be validated by pairwise cooperation among the nodes. For example, a grandparent node may not have access to communicate directly with a grandchild node. The intervening child node may thus be responsible for validating data from the grandchild node and communicating validated data to the grandparent node. Similarly, the grandchild node may have access to communicate with further upstream nodes with which the intervening child node does not, and thus the grandchild node may thus be responsible for validating data from the further upstream nodes and communicating validated data to the intervening child node.

In an example, a participating node can bear a signature or certificate that indicates that the node complies with a specified validation standard. The certificate can be issued by a central certification system based on periodic audit of the node's validation mechanisms.

In an example implementation, a system can implement a cryptographic certificate mechanism to allow downstream nodes to validate data even when they may not have access to communicate with the original source nodes. For example, a source node can generate a key pair (public key, private key). The public key may be distributed to all downstream nodes that rely on the context component provided by the source node. The private key may be securely stored by the source node. The source node may sign each context component with its private key. This creates a digital signature that may be attached to the context component.

Downstream nodes may receive the signed context component and can use the public key of the source node to verify the digital signature. If the signature is valid, the context component may be validated. Downstream nodes can generate further context components based on the signed context component. Each context component generated using the signed context component can be tagged or otherwise marked or associated with the digital signature. A generated context component can have multiple digital signatures associated with multiple input context components used in the generation of the generated context component.

A downstream node can receive a context component having one or more digital signatures or certificates associated therewith. The downstream node may not have access to directly verify with the source node a current validity state of the underlying data. However, the downstream node can reference a centralized authority server that maintains a certificate revocation list. A data source node can revoke its public key or certificate when the underlying data becomes stale. The downstream node can check whether all certificates associated with the context component are still valid or have been revoked. If the public key or certificate is found on the revocation list, the downstream node can determine that the context component is invalid. The downstream node can delete the context component. The downstream node can request a replacement from the sending node. In an example, a node can be configured to only use signed data.

Consider a scenario where a user updates health information in a health application. This update triggers a cascade of changes in the context graph. The health application, acting as a source node, generates a new context component reflecting the updated information and signs it using its private key. The signature is timestamped to indicate the time of the update. As the context component propagates up the graph, each node verifies the signature using the public key of the sending node. If the signature is valid, the node re-signs the component with its own private key, ensuring that the integrity and authenticity of the data are maintained throughout the process. The timestamped signatures allow nodes to identify and discard outdated components, ensuring that only current and valid data is used for inference. This mechanism ensures that the machine-learned model system always receives the most up-to-date and reliable context information.

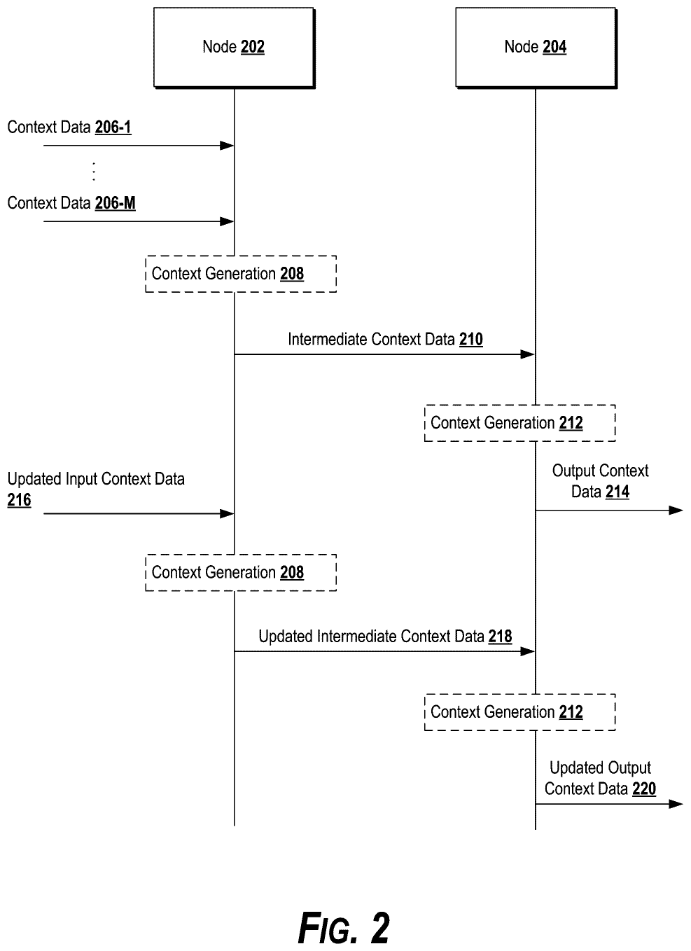

FIG. 2 is a block diagram of an example communication data flow between two nodes according to aspects of the present disclosure. A node 202 can be a child node of node 204. Node 202 can receive one or context components from upstream nodes. For example, node 202 can receive context data 206-1, . . . , 206-M. Node 202 can perform a context generation operation 208 to generate intermediate context data 210. Node 202 can transmit intermediate context data 210 to node 204. Node 204 can, based on intermediate context data 210 and any other context data received from other nodes, perform a context generation operation 212 to generate output context data 214. Node 204 can output context data 214 to one or more other nodes (e.g., to another node of context nodes 106; to input node 104; etc.).

After performing context generation 208, node 202 can receive updated input context data 216. Updated input context data 216 can correspond to any one or more of context data 206-1, . . . , 206-M (e.g., updated context values or attributes associated therewith; updated certificate(s); etc.). Based on updated input context data 216 and any one or more of context data 206-1, . . . , 206-M (e.g., that were not updated), node 202 can perform context generation 208 to generate updated intermediate context data 218. Node 202 can output updated intermediate context data 218 to node 204 to replace intermediate context data 210. Node 202 can output updated intermediate context data 218 to instruct node 204 to delete intermediate context data 210 and any dependencies therefrom.

Based on updated intermediate context data 218 and any one or more of other context components received by node 204, node 204 can perform context generation 212 to generate updated output context data 220. Node 204 can output updated output context data 220 to a downstream node to replace output context data 214. Node 204 can output updated output context data 220 to instruct a downstream node to delete output context data 214 and any dependencies therefrom.

In this manner, for instance, updates to context data can propagate from node to node through the context tree. The updates can propagate from leaf to root, such that the root can receive refreshed context components or instructions to purge stale context components, even if the root node itself is not in direct communication with the data source nodes.

Nodes 202, 204 can include or be implemented by one or more computing devices or systems. For example, each node can correspond to an individual computing device or system. A computing device or system can implement one or more of context nodes 202, 204. A node can be implemented using hardware or software configured to execute one or more context data processing operations. For example, nodes 202, 204 can include one or more processors and memory. The memory can store computer-executable instructions that, when executed by the one or more processors, cause the nodes to perform operations. The nodes can be implemented by one or more virtual machines or containers. Nodes 202, 204 can be any one or more of nodes 108 to 120 of context nodes 106.

Context data 206-1, . . . , 206-M can include a variety of data in one or multiple datatypes. Context data 206-1, . . . , 206-M can include one or multiple modalities of data, such as text or other symbolic data, audio, imagery (e.g., still or video), etc. Context data 206-1, . . . , 206-M can be input by a user, obtained from one or more sensors of a device, retrieved from storage, received over a network, etc. At least a portion of context data 206-1, . . . , 206-M can be generated by machine-learned model(s) executing at or on behalf of an upstream node. Context data 206-1, . . . , 206-M can be an input context component to node 202. Context data 206-1, . . . , 206-M can be an output context component from an upstream node.

Context generation 208 can include operations implemented by one or more machine-learned model(s) (e.g., a machine-learned context generation model). Context generation 208 can include a variety of operations that transform the input context data into context representations for downstream nodes. These operations can be simple or complex, depending on the application. For example, context generation 208 can involve aggregating data from multiple sources, performing feature extraction, or applying dimensionality reduction techniques to reduce the complexity of the data. For example, a machine-learned model can be trained to generate a summary of a collection of text documents, to translate text from one language to another, to parse images, to predict attribute values of a dataset, etc. In general, an operation can include executing inference of a machine-learned model over at least a portion of context data 206-1, . . . , 206-M. The output of the machine-learned model can then be used to generate intermediate context data 210.

Intermediate context data 210 can include a context component output from node 202 and input to node 204. With respect to node 202, intermediate context data 210 can be an output context component. With respect to node 204, intermediate context data 210 can be an input context component. Intermediate context data 210 can be the same or different modality(ies) as context data 206-1, . . . , 206-M.

Context generation 212 can include operations implemented by one or more machine-learned model(s) (e.g., a machine-learned context generation model). Context generation 212 can include a variety of operations that transform the input context data into context representations for downstream nodes. These operations can be simple or complex, depending on the application. For example, context generation 212 can involve aggregating data from multiple sources, performing feature extraction, or applying dimensionality reduction techniques to reduce the complexity of the data. For example, a machine-learned model can be trained to generate a summary of a collection of text documents, to translate text from one language to another, to parse images, to predict attribute values of a dataset, etc. In general, an operation can include executing inference of a machine-learned model over at least a portion of intermediate context data 210. The output of the machine-learned model can then be used to generate output context data 214.

Output context data 214 can include a context component output from node 204 and input to one or more downstream nodes.

Node 202 can store a data record that associates one or more of context data 206-1, . . . , 206-M with the intermediate context data 210. For example, one or more of context data 206-1, . . . , 206-M may be used to generate intermediate context data 210. The one or more of context data 206-1, . . . , 206-M that are used to generate intermediate context data 210 can be indicated in a data record associated with intermediate context data 210 so that the dependencies of intermediate context data 210 can be traced after generation.

Updated input context data 216 can include one or more replacement values for any one or more of context data 206-1, . . . , 206-M. Updated input context data 216 can include an instruction to delete any one or more of context data 206-1, . . . , 206-M or any context components dependent therefrom.

For example, receiving updated input context data 216 can trigger initiation of a replacement for intermediate context data 210. For instance, the received update can be linked to intermediate context data 210 using the stored data record. For example, an update received from a child node can identify a prior context component that is superseded thereby. The prior context component or an identity of the child node can be used to query the stored data record to identify intermediate context data 210 as dependent thereon. In this manner, node 202 can perform initiating, based on the data record, the generation of a replacement context component for the intermediate context data 210.

The replacement process can be terminated prior to outputting the replacement to a downstream node (e.g., node 204). The replacement process can be terminated prior to, during, or after context generation 208 is performed based on the update. For example, node 202 can detect an alignment between intermediate context data 210 and the expected replacement value. The alignment can be determined prior to, during, or after context generation 208 is performed based on the update. The alignment can include an identity between intermediate context data 210 and the expected replacement value. The alignment can be based on a difference measure being below a threshold (e.g., a cosine similarity measure below a threshold similarity). Detecting the alignment can include determining that the intermediate context data 210 is independent of data changed by the update to the at least one of the one or more input context components. This early termination can avoid propagating updates that do not in fact update the existing values. In this manner, for instance, downstream nodes can maintain valid cached values without having to recompute the same values again. For example, node 202 can, based on detecting an alignment between the replacement context component and the output context component, not output, to node 204, the replacement context component to replace intermediate context data 210.

The replacement process can be carried out to completion. For example, node 202 can, based on generating the replacement context component, output, to node 204, the replacement context component to replace the intermediate context data 210.

Updated intermediate context data 218 can include the replacement context component generated via context generation 208. Update intermediate context data 218 can include one or more replacement values for intermediate context data 210. Updated intermediate context data 218 can include an instruction to delete intermediate context data 210 or any context components dependent therefrom.

Just as node 202 responded to updated input context data 216, node 204 can respond to updated intermediate context data 218. Node 204 can respond in the same way as node 202 or can respond differently. For example, updated output context data 220 can include a replacement context component generated via context generation 212. Update output context data 220 can include one or more replacement values for output context data 214. Updated output context data 220 can include an instruction to delete output context data 214 or any context components or inferences dependent therefrom.

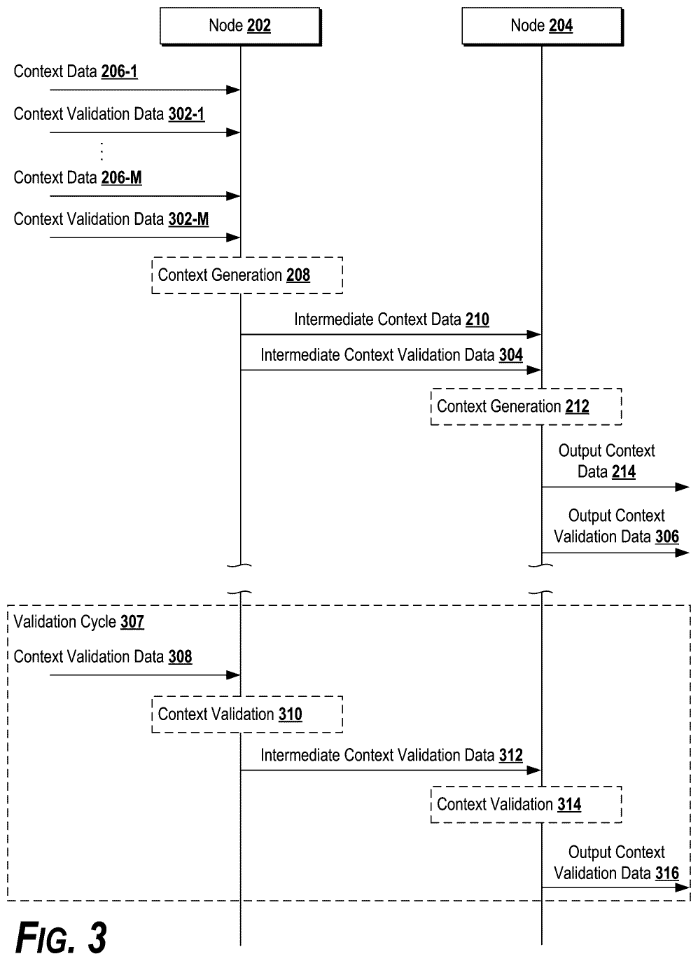

FIG. 3 is a block diagram of an example communication data flow between two nodes according to aspects of the present disclosure. In FIG. 3, validation data flows accompany the context data flows. For instance, context data 206-1, . . . , 206-M can be respectively associated with context validation data 302-1, . . . , 302-M (e.g., one or more certificate(s)). Context validation data can be or include a certificate that operates as a digital signature. A digital signature can be or include a cryptographic hash of a message. The message can include or be derived from context data 206-1, . . . , 206-M. The digital signature can be generated by a node that generated context data 206-1, . . . , 206-M. The digital signature can be generated by a source node that generated data on which context data 206-1, . . . , 206-M is based. The digital signature can be generated using a private key. The signature can be validated by using a public key and checking against a certificate revocation list. The certificate revocation list can be maintained by a centralized authority server.

Context validation data 302-1, . . . , 302-M can include one or more permissions. The permissions can include an expiration. The expiration can indicate a time when context data 206-1, . . . , 206-M is no longer valid. Based on the expiration, a node can determine whether to use or to delete context data 206-1, . . . , 206-M. If the expiration has passed, a node (e.g., node 202) can request a new certificate or permission from a source node. If the expiration has not passed, a node (e.g., node 202) can use context data 206-1, . . . , 206-M.

Intermediate context validation data 304 can include one or more certificate(s). A certificate can be or include a digital signature. A digital signature can be or include a cryptographic hash of a message. The message can include or be derived from any one or more of context data 206-1, . . . , 206-M, or intermediate context data 210. The digital signature can be generated by node 202 to sign intermediate context data 210. The certificate(s) can include all certificate(s) obtained from any context data used to generate intermediate context data 210. The digital signature can be generated using a private key. The signature can be validated by using a public key and checking against a certificate revocation list. The certificate revocation list can be maintained by a centralized authority server.

Intermediate context validation data 304 can include one or more permissions. The permissions can include an expiration. The expiration can indicate a time when context data 210 is no longer valid. Based on the expiration, a node can determine whether to use or to delete context data 210. If the expiration has passed, a node (e.g., node 204) can request a new certificate or permission from a source node (e.g., node 202). If the expiration has not passed, a node (e.g., node 204) can use context data 210. An expiration of context data 210 can be automatically set to the earliest expiration of all certificates associated with context data 206-1, . . . , 206-M.

Output context validation data 306 can include one or more certificate(s). A certificate can be or include a digital signature. A digital signature can be or include a cryptographic hash of a message. The message can include or be derived from any one or more of context data 206-1, . . . , 206-M, intermediate context data 210, or output context data 214. The digital signature can be generated by node 204 to sign output context data 214. The certificate(s) can include all certificate(s) obtained from any context data used to generate output context data 214. The digital signature can be generated using a private key. The signature can be validated by using a public key and checking against a certificate revocation list. The certificate revocation list can be maintained by a centralized authority server.

Output context validation data 306 can include one or more permissions. The permissions can include an expiration. The expiration can indicate a time when context data 214 is no longer valid. Based on the expiration, a node (e.g., node 104) can determine whether to use or to delete context data 214. If the expiration has passed, a node can request a new certificate or permission from a source node (e.g., node 204). If the expiration has not passed, a node (e.g., node 104) can use context data 214. An expiration of context data 214 can be automatically set to the earliest expiration of all certificates associated with intermediate context data 210.

Context validation data 302-1, . . . , 302-M, intermediate context validation data 304 or output context validation data 306 may be omitted. In some instances, transmission of a context component is an implicit signal that it is valid for at least some default duration (e.g., defined in number of uses, such as for a single inference use, or a temporal interval, such as for 1 day, 1 hour, etc.).

A validation cycle 307 can execute to validate data cached at or output from one or more of nodes 202 or 204. Validation cycle 307 can initiate responsive to receiving context validation data 308 at node 202.

Context validation data 308 (e.g., updated input context data 216) can include an update to a context value or a certificate attached to context value. Context validation data 308 can be received from a source node. Context validation data 308 can include a new certificate for a source node. Context validation data 308 can include a new permission for a source node. Context validation data 308 can include an expiration for a certificate or permission. Context validation data 308 can be the same format as a corresponding one of context data 206-1, . . . , 206-M or context validation data 302-1, . . . , 302-M.

Context validation data 308 can include a notification that a context component is no longer valid. The notification can be sent from a source node to a downstream node. The notification can include a reason for the invalidation. The reason can include a change to the underlying data or attributes associated therewith, a change to a certificate, or an expiration of a certificate. The notification can cause the downstream node to delete the invalid context component and any context components or inferences generated therefrom. Based on receiving context validation data 308, node 202 can perform context validation 310.

Context validation 310 can include one or more validation operations performed by node 202. Context validation 310 can include performing one or more cryptographic operations using a public key architecture to identify a certificate associated with context validation data or one or more cached values. Context validation 310 can include generating a replacement context component based on new context values communicated by context validation data 308 (e.g., by executing context generation 208 over the new context). Context validation 310 can generate intermediate context validation data 312.

Intermediate context validation data 312 can include a replacement context component for intermediate context data 210.

Intermediate context validation data 312 can include an update to a context value or a certificate attached to context value. Intermediate context validation data 312 can include a new certificate for intermediate context data 210. Intermediate context validation data 312 can include a new permission for intermediate context data 210. Intermediate context validation data 312 can include an expiration for a certificate or permission. Intermediate context validation data 312 can be the same format as a corresponding one of intermediate context data 210 or intermediate context validation data 304.

Intermediate context validation data 312 can include a notification that a context component (e.g., intermediate context component 210) is no longer valid. The notification can be sent from a source node (e.g., node 202) to a downstream node (e.g., node 204). The notification can include a reason for the invalidation. The reason can include a change to the underlying data or attributes associated therewith, a change to a certificate, or an expiration of a certificate. The notification can cause the downstream node to delete the invalid context component and any context components or inferences generated therefrom. Based on receiving intermediate context validation data 312, node 204 can perform context validation 314.

Context validation 314 can include one or more validation operations performed by node 204. Context validation 314 can include performing one or more cryptographic operations using a public key architecture to identify a certificate associated with context validation data or one or more cached values. Context validation 314 can include generating a replacement context component based on new context values communicated by context validation data 312 (e.g., by executing context generation 212 over the new context). Context validation 314 can generate output context validation data 316.

Output context validation data 316 can include a replacement context component for output context data 214.

Output context validation data 316 can include an update to a context value or a certificate attached to context value. Output context validation data 316 can include a new certificate for output context data 214. Output context validation data 316 can include a new permission for output context data 214. Output context validation data 316 can include an expiration for a certificate or permission. Output context validation data 316 can be the same format as a corresponding one of output context data 214 or output context validation data 306.

Output context validation data 316 can include a notification that a context component (e.g., output context component 214) is no longer valid. The notification can be sent from a source node (e.g., node 204) to a downstream node (e.g., node 104). The notification can include a reason for the invalidation. The reason can include a change to the underlying data or attributes associated therewith, a change to a certificate, or an expiration of a certificate. The notification can cause the downstream node to delete the invalid context component and any context components or inferences generated therefrom.

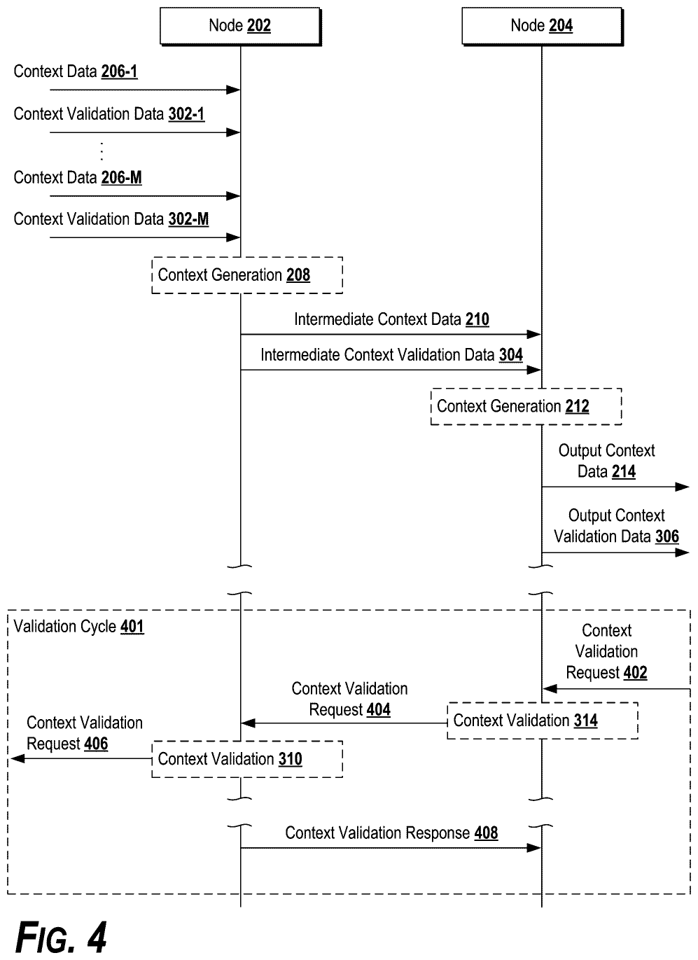

FIG. 4 is a block diagram of an example communication data flow between two nodes according to aspects of the present disclosure. In FIG. 4, a validation cycle 401 can be initiated by a parent node that requests validation from a child node.

For instance, validation cycle 401 can be initiated by a trigger condition. A trigger condition can include receipt at node 204 of context validation request 402. Node 204 can receive context validation request 402 from a downstream node that received context components from node 204, such as input node 104. A trigger condition can include an internal trigger, such as a detection by node 204 of an expiration of a certificate associated with context processed by or output from node 204. In an example, a trigger condition can be receiving a new context component or initiating generation of a new output context component using cached context components. A validity of a cached context component can be confirmed at each use. For instance, node 204 can receive a new context component and have, cached at node 204, intermediate context data 210. Before re-using intermediate context data 210 to regenerate output context data 214, node 204 can initiate a validation cycle to validate intermediate context data 210.

Upon detection of the trigger condition, node 204 can execute context validation 314. Context validation 314 can include one or more operations that confirm a validity of the input context components processed by node 204, such as intermediate context data 210 from node 202. Context validation 314 can include issuing a context validation request 404 to node 202 to confirm validation of intermediate context data 210.

Node 202 can, based on receiving context validation request 404, execute context validation 310. Context validation 310 can include performing one or more validations of received contexts at node 202, including issuing further context validation requests 406 to upstream nodes on which intermediate context data 210 depends. In general, validation cycle 401 can include node 202 responding with context validation response 408 that confirms validation or denies validation. Node 202 may not respond with any validation response, or can respond without confirming validity. Based on receiving a response indicating a valid context status, or not receiving a response indicating a valid context status, node 204 can determine what valid context can be used to propagate context downstream (e.g., in response to context validation request 402, or in furtherance of generating new output context components using or not using cached context).

Further example implementations of the techniques described in FIGS. 1 to 4 are described with respect to the following figures.

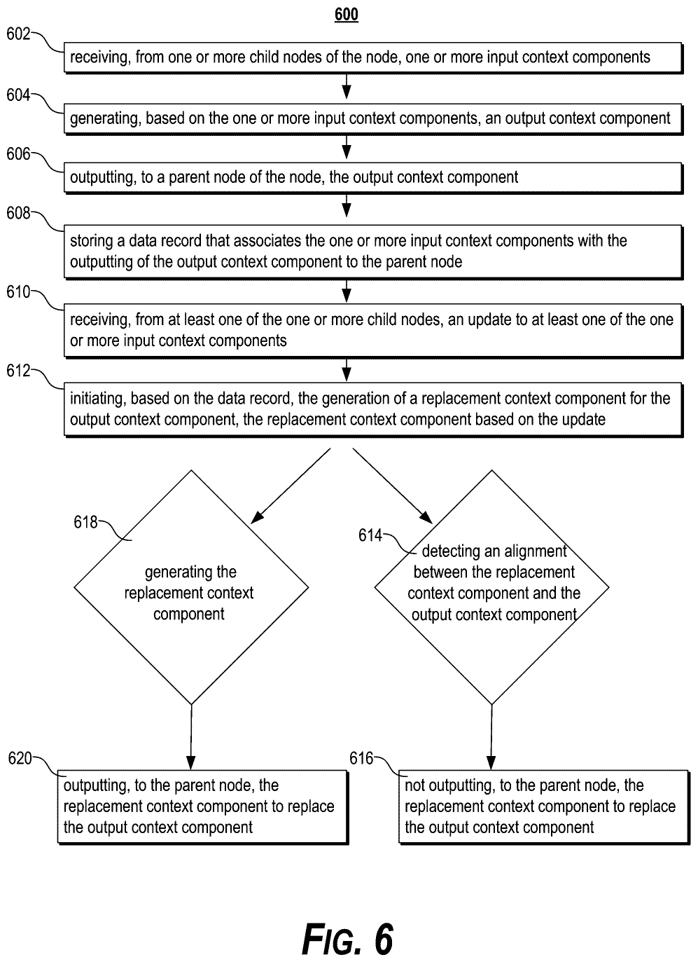

FIG. 6 depicts a flowchart of a method 600 for validating data at a node in a hierarchical input pipeline for a machine-learned model system according to aspects of the present disclosure. For instance, an example machine-learned model system can include machine-learned model system 100.

One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein. For example, one or more portion(s) of example method 500 can be operations performed by a computing system. For example, a computing system can include a memory that stores, on non-transitory tangible computer-readable media, instructions that are executable by one or more processors to cause the computing system to perform operations, the operations comprising one or more portion(s) of example method 500.

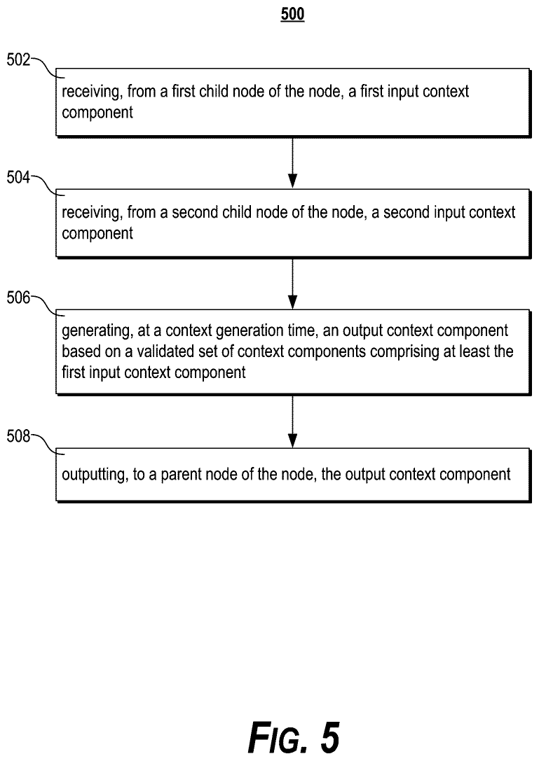

FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include receiving, from a first child node of the node, a first input context component. For example, node 204 can receive context component(s) from a plurality of nodes. The first input context component can be a context component received from one of the plurality of nodes.

At 504, example method 500 can include receiving, from a second child node of the node, a second input context component. For example, node 204 can receive intermediate context data 210 from node 202.

At 506, example method 500 can include generating, at a context generation time, an output context component based on a validated set of context components comprising at least the first input context component. For example, node 204 can execute context generation 212 to generate output context data 214 based on a set of valid contexts. In an example, the set of valid contexts can include the first input context component, such as when the first input context component is newly received or newly validated. The second input context component (e.g., intermediate context data 210) can be cached at node 204. It may be desired to confirm that the second input context component is still valid at the time at which node 204 is regenerating a context component to pass downstream (e.g., to node 104).

In some implementations of example method 500, the validated set of context components includes the second input context component based on receiving, from the second child node, a communication that indicates a valid context status for the second input context component at the context generation time. In an example, node 204 can receive a communication containing intermediate context data 210. In an example, node 204 can receive a response 408 from node 202 that indicates that intermediate context data 210 is valid. Node 204 can receive a response that contains an updated set of context, such that the response itself contains updated values for the second context component.

In some implementations of example method 500, the validated set of context components does not comprise the second input context component based on not receiving the communication that indicates the valid context status at the context generation time. In an example, node 204 may not receive a response from node 202, or may receive a response that fails to indicate a valid status for intermediate context data 210. Based on the failure to validate, node 204 can generate a context component not based on intermediate context data 210. In an example, node 204 can receive a communication containing new values for intermediate context data 210, such that the output context component may be generated based on the new values rather than the prior values of intermediate context data 210.

At 508, example method 500 can include outputting, to a parent node of the node, the output context component. In some implementations of example method 500, outputting, to the parent node of the node, the output context component includes outputting, to an input node associated with the machine-learned model system, the output context component. For example, node 120 (e.g., node 204) can output a context component to an input node of a machine-learned model system (e.g., node 104). In some implementations, example method 500 includes inputting, to a machine-learned model of the machine-learned model system, at least a portion of the output context component. The input node can receive the context and provide, to a machine-learned model (e.g., model 102) an input based on the context component. In some implementations, example method 500 includes generating, using the machine-learned model and based on the inputted portion of the output context component, a prediction output. In some implementations of example method 500, the second input context component includes data associated with a user account, and wherein the prediction output includes predicted data associated with the user account.

In some implementations, example method 500 includes receiving, from the second child node, the communication that indicates the valid context status. In some implementations, example method 500 includes generating the output context component based on the second input context component.

In some implementations of example method 500, the communication includes a cryptographic signature associated with the second child node. For example, node 204 can receive intermediate context validation data 304 or can receive a response 408 that contains a certificate indicating a cryptographic signature associated with node 202, such as a signature confirmed and passed through by node 202, a signature created by node 202, etc.

In some implementations, example method 500 includes not receiving, from the second child node, the context validation response that indicates the valid context status. In some implementations, example method 500 includes generating the output context component not based on the second input context component. In some implementations of example method 500, not receiving, from the second child node, the context validation response that indicates the valid context status includes not receiving any response from the second child node. In some implementations of example method 500, not receiving, from the second child node, the context validation response that indicates the valid context status includes receiving a response from the second child node that does not indicate the valid context status. In some implementations of example method 500, not receiving, from the second child node, the context validation response that indicates the valid context status includes receiving a response from the second child node that indicates an invalid context status.

In some implementations, example method 500 includes deleting the second input context component. For example, if context validation response 408 is not received, or if it indicates an invalid status, or if it contains instructions to delete intermediate context data 210, node 204 can delete intermediate context data 210.

In some implementations, example method 500 includes receiving the response from the second child node that does not indicate the valid context status, wherein the response includes one or more updated values for the second input context component.

In some implementations, example method 500 includes requesting, from the second child node, context validation data that indicates the context status for the second input context component. For example, node 204 can issue context validation request 404.

In some implementations, example method 500 includes requesting the context validation data responsive to a trigger condition, wherein the trigger condition corresponds to an expiration of an authorization associated with the second input context component.

In some implementations, example method 500 includes receiving, from the second child node, the second input context component. In some implementations, example method 500 includes subsequent to receiving the second input context component, receiving, from the second child node, a context update. The update can be, for instance, updated intermediate context data 218, intermediate context validation data 312, etc. In some implementations of example method 500, the context update includes a communication indicating a deletion instruction associated with the second input context component. In some implementations of example method 500, the context update includes one or more updated values for the second input context component.

FIG. 6 depicts a flowchart of a method 600 for validating data at a node in a hierarchical input pipeline for a machine-learned model system according to aspects of the present disclosure. For instance, an example machine-learned model system can include machine-learned model system 100.

One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein. For example, one or more portion(s) of example method 600 can be operations performed by a computing system. For example, a computing system can include a memory that stores, on non-transitory tangible computer-readable media, instructions that are executable by one or more processors to cause the computing system to perform operations, the operations comprising one or more portion(s) of example method 600.

FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, example method 600 can include receiving, from one or more child nodes of the node, one or more input context components.

At 604, example method 600 can include generating, based on the one or more input context components, an output context component.

At 606, example method 600 can include outputting, to a parent node of the node, the output context component.

At 608, example method 600 can include storing a data record that associates the one or more input context components with the outputting of the output context component to the parent node.

At 610, example method 600 can include receiving, from at least one of the one or more child nodes, an update to at least one of the one or more input context components.

At 612, example method 600 can include initiating, based on the data record, the generation of a replacement context component for the output context component, the replacement context component based on the update.

At 614, example method 600 can include detecting an alignment between the replacement context component and the output context component.

At 616, example method 600 can include, based on 614, not outputting, to the parent node, the replacement context component to replace the output context component.

At 618, example method 600 can include generating the replacement context component. For instance, generating the replacement context component may not be terminated early based on 614 (e.g., if insufficient alignment is detected).

At 620, example method 600 can include, based on 618, outputting, to the parent node, the replacement context component to replace the output context component.

In some implementations of example method 600, detecting the alignment includes determining that the output context component is independent of data changed by the update to the at least one of the one or more input context components.

In some implementations of example method 600, generating the output context component includes inputting the one or more input context components to a machine-learned context generation model. In some implementations of example method 600, generating the output context component includes generating, by the machine-learned context generation model and based on the one or more input context components, an output. In some implementations of example method 600, generating the output context component includes generating the output context component based on the output.

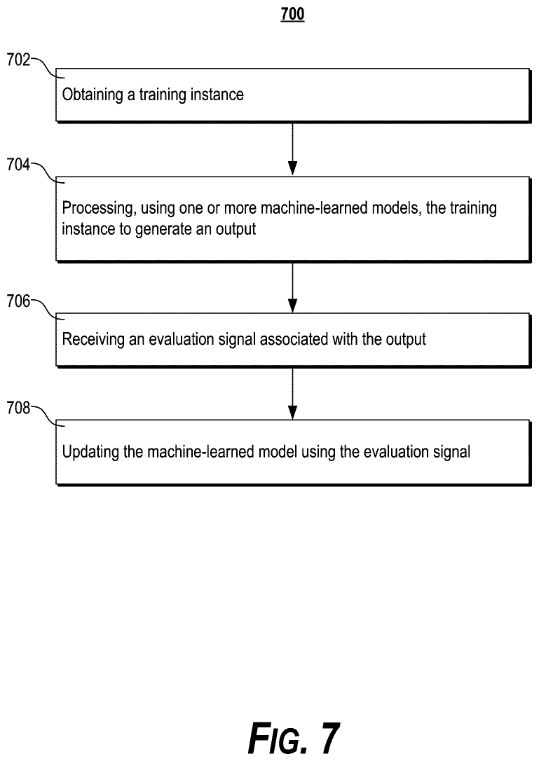

FIG. 7 depicts a flowchart of a method 700 for training one or more machine-learned models according to aspects of the present disclosure. For instance, an example machine-learned model can include one or more machine-learned models used by an encoder operator, one or more machine-learned models used by machine-learned model system 100, one or more machine-learned models used by one of context nodes 106, etc.

One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models. For example, one or more portion(s) of example method 700 can be operations performed by a computing system. For example, a computing system can include a memory that stores, on non-transitory tangible computer-readable media, instructions that are executable by one or more processors to cause the computing system to perform operations, the operations comprising one or more portion(s) of example method 700.

FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining a training instance. A set of training data can include a plurality of training instances divided between multiple datasets (e.g., a training dataset, a validation dataset, or testing dataset). A training instance can be labeled or unlabeled. Although referred to in example method 700 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be directly obtained from the one or more machine-learned models or can be a downstream result of a chain of processing operations that includes an output of the one or more machine-learned models. The output can be a final output or an intermediate output (e.g., a logit value associated with a given final output candidate).

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 700 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types. In some implementations, example method 700 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

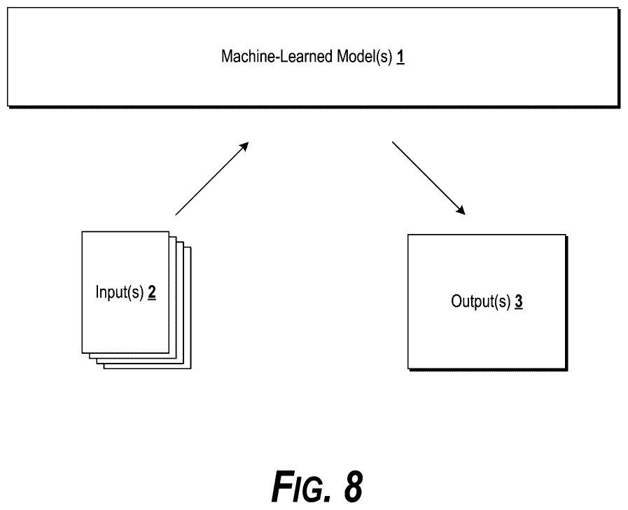

FIG. 8 is a block diagram of an example processing flow for using machine-learned model(s) 1 to process input(s) 2 to generate output(s) 3.

Machine-learned model(s) 1 can be or include any one of or any part of machine-learned models referenced with respect to the preceding figures (e.g., models 106, 402-1, 402-2, etc.). For example, any one or multiple of the following can be a machine-learned model 1: machine-learned model 102, a machine-learned context generation model, etc. Features and variations described herein with respect to machine-learned model 1 are to be understood as describing features and variations of any of the machine-learned models described herein. Where this description references machine-learned model 1 it is to be understood that implementations of each of such other models described herein are implicitly referenced and represented thereby.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

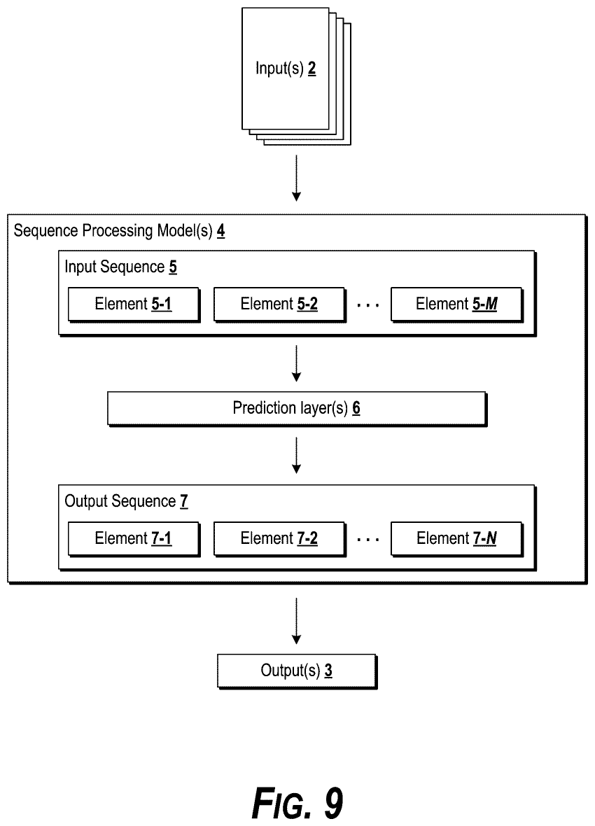

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https: //ai. google/static/documents/palm2techreport. pdf (n. d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 23 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5. The context can include or be descriptive of context components obtained via context nodes 106.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

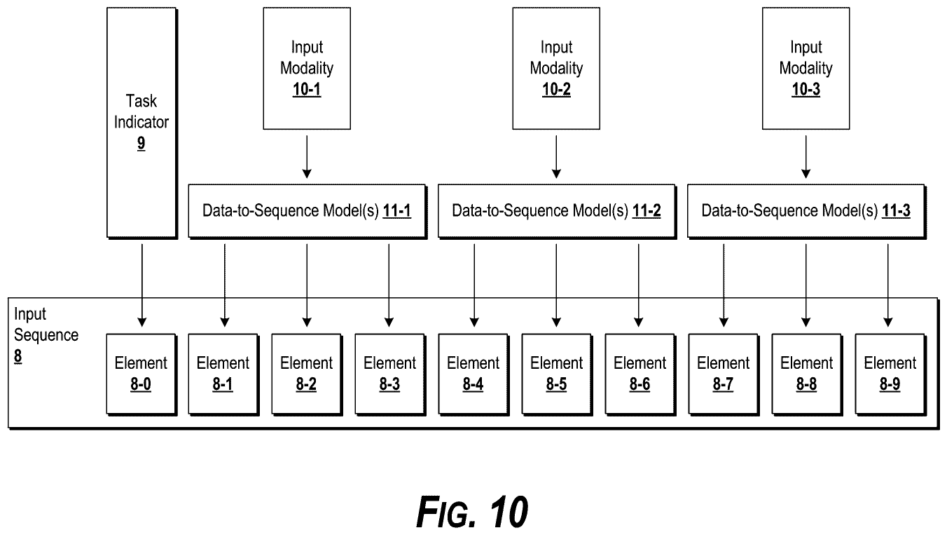

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

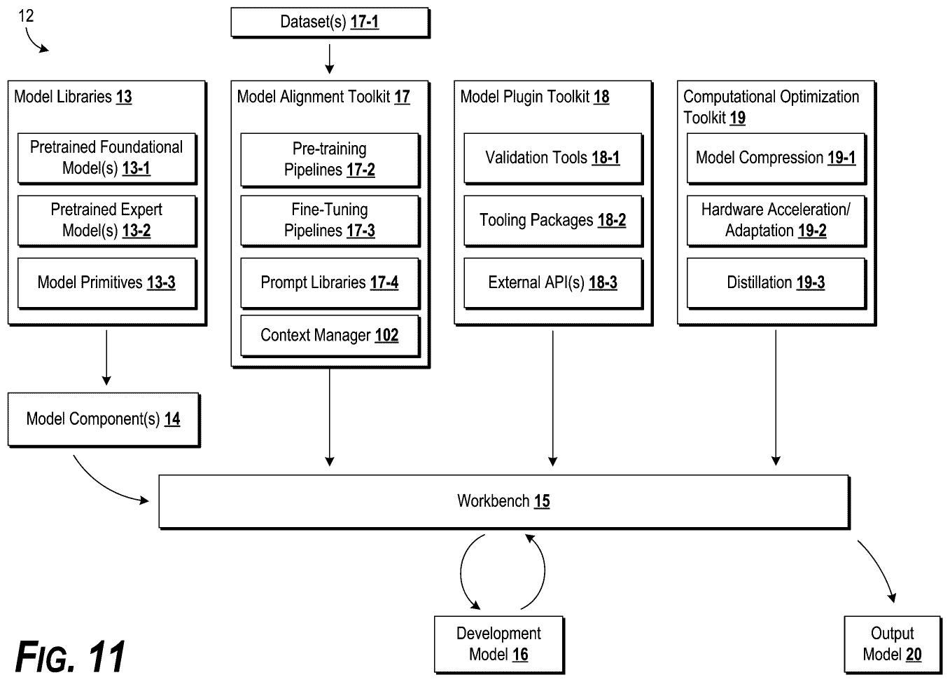

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training methods described herein.

Context manager 102 and corresponding libraries can be provided as a tool for inducing alignment of model outputs over long contexts.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

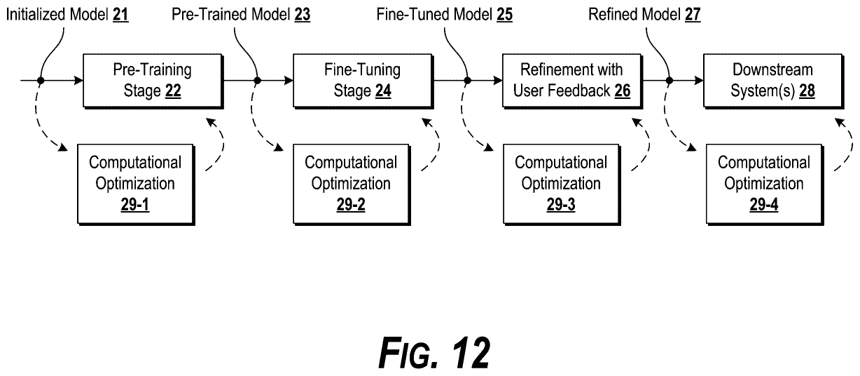

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

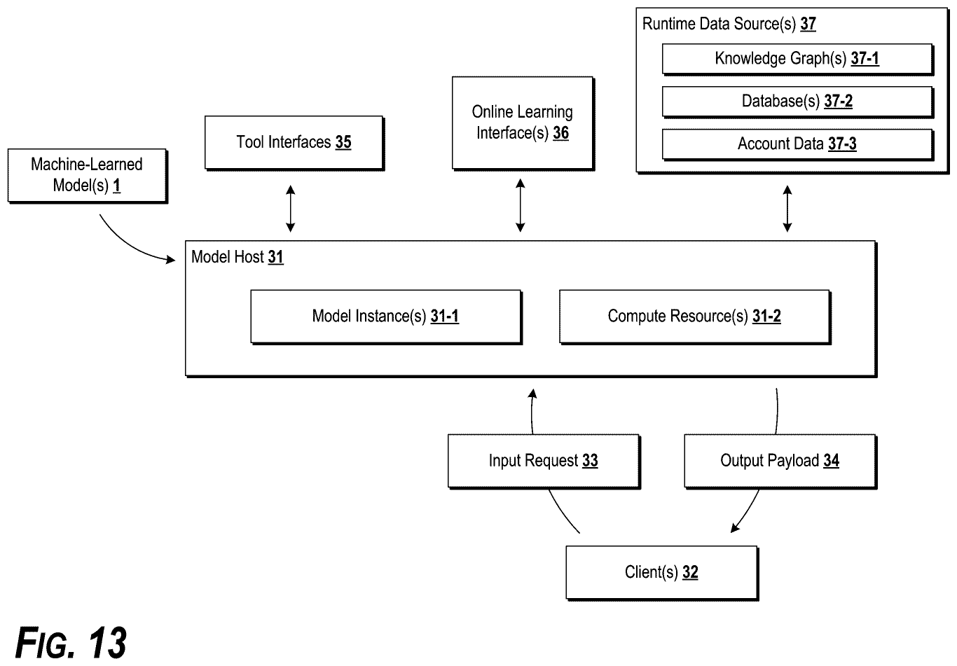

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models.

Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute context manager 102. Model host 31 can receive encoded representations from a context manager 102 executing on client(s) 32. Model host 31 can receive encoded representations from a context manager 102 executing on runtime data source(s) 37. Model host 31 can maintain a cached context graph and receive graph updates from client(s) 32 or runtime data source(s) 37.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function).

Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

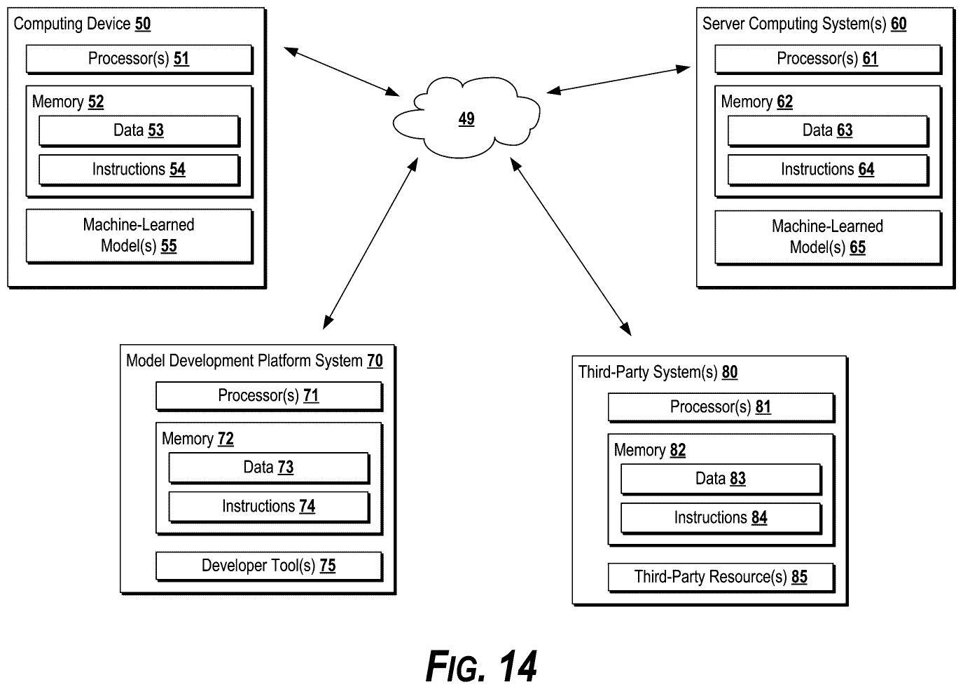

FIG. 14 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 14 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

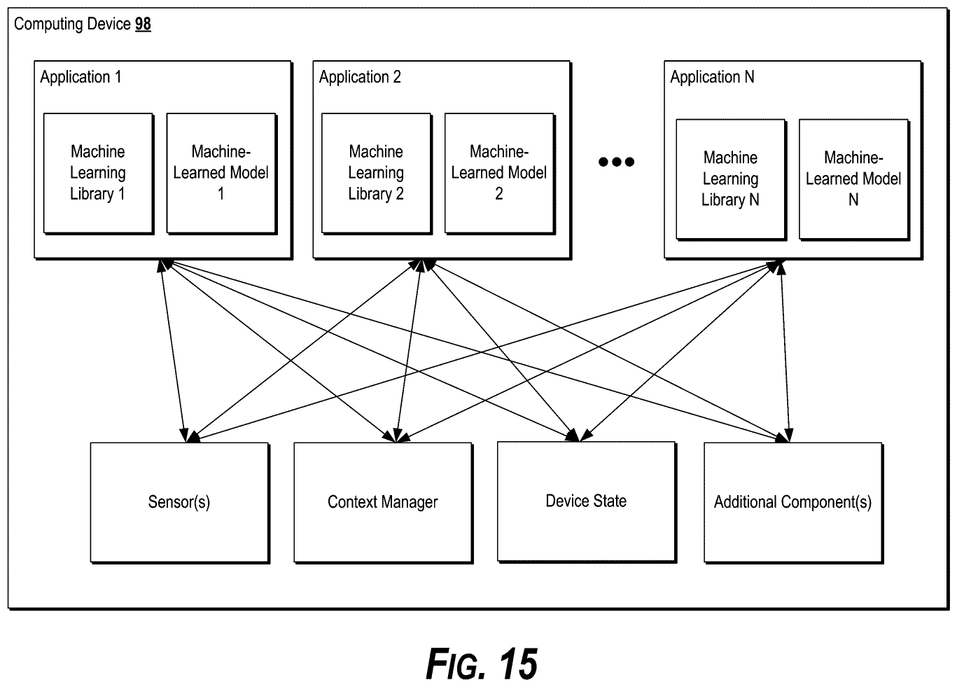

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model.

Example applications include a text messaging application, an email application, a dictation application, a virtual keyboard application, a browser application, etc. Each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

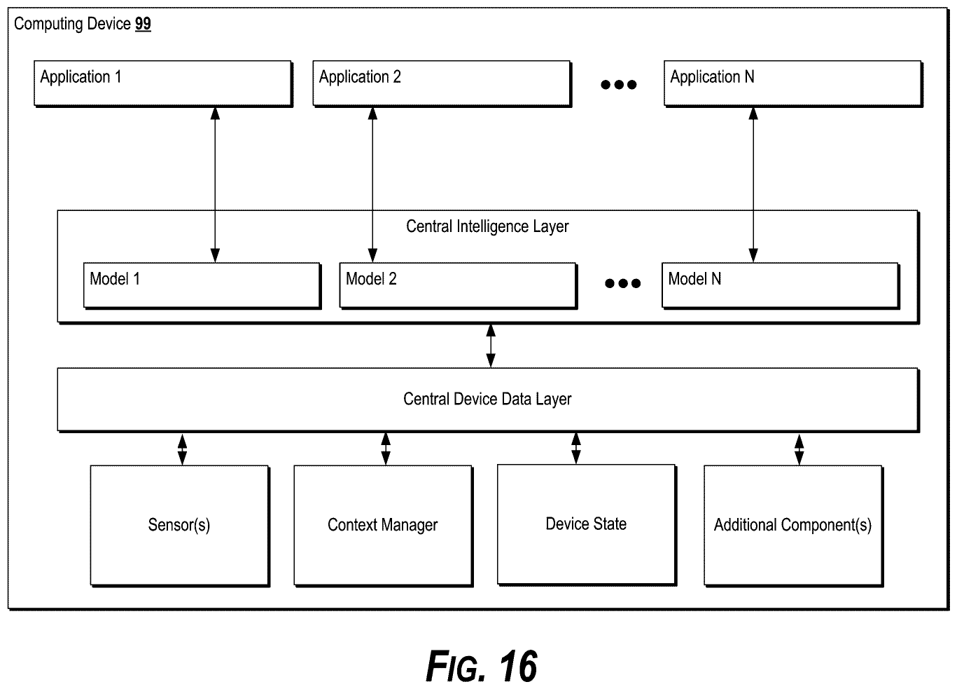

FIG. 16 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. The central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for validating data at a node in a hierarchical input pipeline for a machine-learned model system, the method comprising:
receiving, from a first child node of the node, a first input context component;
receiving, from a second child node of the node, a second input context component;
generating, at a context generation time, an output context component based on a validated set of context components comprising at least the first input context component, wherein:
the validated set of context components comprises the second input context component based on receiving, from the second child node, a communication that indicates a valid context status for the second input context component at the context generation time; or
the validated set of context components does not comprise the second input context component based on not receiving the communication that indicates the valid context status at the context generation time; and
outputting, to a parent node of the node, the output context component.

2. The method of claim 1, comprising:
receiving, from the second child node, the communication that indicates the valid context status; and
generating the output context component based on the second input context component.

3. The method of claim 2, wherein the communication comprises a cryptographic signature associated with the second child node.

4. The method of claim 1, comprising:
not receiving, from the second child node, the communication that indicates the valid context status; and
generating the output context component not based on the second input context component.

5. The method of claim 4, wherein not receiving, from the second child node, the communication that indicates the valid context status comprises:
not receiving any response from the second child node;
receiving a response from the second child node that does not indicate the valid context status; or
receiving a response from the second child node that indicates an invalid context status.

6. The method of claim 4, comprising:
deleting the second input context component.

7. The method of claim 5, comprising:
receiving the response from the second child node that does not indicate the valid context status, wherein the response comprises one or more updated values for the second input context component.

8. The method of claim 1, comprising:
requesting, from the second child node, context validation data that indicates the context status for the second input context component.

9. The method of claim 8, comprising:
requesting the context validation data responsive to a trigger condition, wherein the trigger condition corresponds to an expiration of an authorization associated with the second input context component.

10. The method of claim 1, comprising:
receiving, from the second child node, the second input context component; and
subsequent to receiving the second input context component, receiving, from the second child node, a context update.

11. The method of claim 10, wherein the context update comprises a communication indicating a deletion instruction associated with the second input context component.

12. The method of claim 10, wherein the context update comprises one or more updated values for the second input context component.

13. The method of claim 1, wherein outputting, to the parent node of the node, the output context component comprises:
outputting, to an input node associated with the machine-learned model system, the output context component.

14. The method of claim 13, comprising:
inputting, to a machine-learned model of the machine-learned model system, at least a portion of the output context component; and
generating, using the machine-learned model and based on the inputted portion of the output context component, a prediction output.

15. The method of claim 14, wherein the second input context component comprises data associated with a user account, and wherein the prediction output comprises predicted data associated with the user account.

16. A computer-implemented method for validating data at a node in a hierarchical input pipeline for a machine-learned model system, the method comprising:
receiving, from one or more child nodes of the node, one or more input context components;
generating, based on the one or more input context components, an output context component;
outputting, to a parent node of the node, the output context component;
storing a data record that associates the one or more input context components with the outputting of the output context component to the parent node;
receiving, from at least one of the one or more child nodes, an update to at least one of the one or more input context components;
initiating, based on the data record, the generation of a replacement context component for the output context component, the replacement context component based on the update; and
one of:
based on generating the replacement context component, outputting, to the parent node, the replacement context component to replace the output context component; or
based on detecting an alignment between the replacement context component and the output context component, not outputting, to the parent node, the replacement context component to replace the output context component.

17. The method of claim 16, comprising:
based on generating the replacement context component, outputting, to the parent node, the replacement context component to replace the output context component.

18. The method of claim 16, comprising:
based on detecting the alignment between the replacement context component and the output context component, not outputting, to the parent node, the replacement context component to replace the output context component.

19. The method of claim 18, wherein detecting the alignment comprises:
determining that the output context component is independent of data changed by the update to the at least one of the one or more input context components.

20. The method of claim 16, wherein generating the output context component comprises:
inputting the one or more input context components to a machine-learned context generation model;
generating, by the machine-learned context generation model and based on the one or more input context components, an output; and
generating the output context component based on the output.
